(19) United States
(12) Patent Application Publication
(10) Pub. No.: US 2025/0208987 A1
(43) Pub. Date: Jun. 26, 2025

(54) SYSTEM AND METHOD FOR AUTOMATICALLY SYNCHRONIZING TEST INFORMATION

(71) Applicant: Woven By Toyota, Inc., Tokyo (JP)

(72) Inventors: Benjamin IOLLER, Tokyo (JP); Jilada Eccleston, Tokyo (JP); Antonio Tienda Fernandez, Tokyo (JP); James Cumming, Tokyo (JP); Beck Chen, Tokyo (JP); Cyril Courtoy, Palo Alto, CA (US); Haitham Ahmed, Tokyo (JP)

(73) Assignee: WOVEN BY TOYOTA, INC., Tokyo (JP)

(21) Appl. No.: 18/390,548

(22) Filed: Dec. 20, 2023

(51) Int. Cl. G06F 11/36

(52) U.S. Cl. CPC G06F 11/3692; G06F 11/3698

(57) ABSTRACT

Provided are a system, method, and device for automatically synchronizing test information of a test for testing a software of an embedded system. According to embodiments, the method may be implemented by at least one processor and may include: collecting at least one test result of the testing; determining at least one test case associated with the at least one test result; determining, from among a plurality of test requirements of the at least one test case, at least one test requirement associated with the at least one test result; and synchronizing the at least one test result with the at least one test requirement.

### TECHNICAL FIELD

Systems and methods consistent with example embodiments of the present disclosure relate to test information management, and more particularly, relate to automatically synchronizing test information of a testing of a software associated with a vehicle system.

### BACKGROUND

Testing for a software is required in order to ensure that the software functions as intended, meets the specified requirements, and performs reliably in various scenarios. Software testing is a crucial part of the software development life cycle (SDLC) and is performed to identify defects, errors, or bugs in the software before it is deployed to the actual system.

Whenever the software includes complex features and/or is required to interoperate with another software, the testing of the software becomes complex and may involve multiple procedures and users/stakeholders. For instance, in the context of the development of vehicle-related features in a vehicle system, such as Lane Change Assist, Mobile Smart Keys, and the like, multiple Electronic Control Units (ECUs) may be developed and interoperate with each other in order to perform an intended feature.

For example, each of the multiple ECUs may be managed by different users located at different geographical locations. For instance, a first ECU may be developed by a first developer (e.g., an in-house development engineer of a vehicle manufacturer) located at a first location, and said first ECU may need to interoperate with a second ECU developed by a second developer (e.g., a vendor) located at a second location. As another example, the first ECU may be tested by a third user (e.g., a test engineer) located at a third location. In addition, the first ECU may interoperate with a hardware (e.g., a physical ECU, etc.) managed by a fourth user located at a fourth location, and thus, the testing of the first ECU would require the involvement of the hardware.

In view of the above, it is important to ensure that information associated with a testing, such as information of test requirements, information of test results, or the like, are timely synchronized and are appropriately presented to the users such that the users involved in the testing are always on the same page on the test information and have a consistent understanding on the testing.

Nevertheless, in the related art, it is unduly difficult to ensure that all testing information is timely and consistently synchronized, particularly when the testing involves a significant number of test artifacts (e.g., ECUs developed by different users, etc.) and/or a significant number of users, the associated users are located at different geographical locations (which may result in communication delay due to time zone differences, etc.), and/or the associated users have different levels technical background.

Further, in the related art, the process of synchronizing test results to specific test cases and to the corresponding test requirements often requires manual intervention from the users, which may lead to human errors, delays, and reduced productivity. For instance, the user who is executing the testing (e.g., the aforesaid third user) may need to manually collect the information or data associated with the test result (e.g., test logs, metadata, etc.), to review the data and further process the data thereafter, in order to prepare the test results in a readable format and to map the test results to the corresponding test case and the associated test requirement thereafter.

Furthermore, in the related art, it is challenging to appropriately present the test information to all users associated with a testing, particularly when the number of users involved in the testing is huge. For example, the test information may be prepared to include a significant amount of technical details, which may not be understandable by a user(s) who does not have good technical background. Conversely, the test information may be prepared to include only generic information and with less technical details, which may not be informative to a user(s) who has good technical background and would like to review the test information in details.

In view of the above, the test information management approaches and processes in the related art are time-consuming, ineffective, and burdensome for the users. As a result, it is unduly difficult (if not impossible) to ensure that all test information is timely and consistently synchronized. Accordingly, the testing of a software in the related art may be time-consuming and inefficient, and the development of the software may be delayed.

### SUMMARY

Example embodiments consistent with the present disclosure provide methods, systems, and apparatuses for efficiently and effectively managing test information of a testing. Specifically, example embodiments of the present disclosure provide systems, methods, devices, or the like, which efficiently and effectively synchronize and present test information. Ultimately, example embodiments of the present disclosure enable the test information to be timely and consistently synchronized, and enable the synchronized test information to be effectively and efficiently presented to users with different levels of technical background.

According to embodiments, a method for automatically synchronizing test information of a testing may be provided. The method may be implemented by at least one processor, and may include: collecting at least one test result of the testing; determining at least one test case associated with the at least one test result; determining, from among a plurality of test requirements of the at least one test case, at least one test requirement associated with the at least one test result; and synchronizing the at least one test result with the at least one test requirement. The testing may include testing of a software of a vehicle system, and the software may include a virtual electronic control unit (ECU).

According to embodiments, the synchronizing the at least one test result with the at least one test requirement may include: generating a mapping of the at least one test result and the determined at least one test requirement. Alternatively or additionally, the synchronizing the at least one test result with the at least one test requirement may include: updating a mapping of the at least one test result and the determined at least one test requirement.

According to embodiments, the collecting the at least one test result may include: establishing a communication with at least one test execution environment; gathering, from the a least one test execution environment, one or more test data; and extracting, from the one or more test data, information associated with the test result.

According to embodiments, the determining the at least one test case may include: processing the at least one test result to obtain at least one identity parameter associated with the at least one test case; and identifying, based on the at least one identity parameter, the at least one test case. The at least one identity parameter may include at least one of: a keyword associated with the at least one test case, a unique identifier (ID) associated with the at least one test case, and a tag associated with the at least one test case.

According to embodiments, the determining the at least one test requirement may include: processing the at least one test result to obtain at least one test parameter associated with the at least one test requirement; and determining, based on the at least one test parameter, the at least one test requirement from among a plurality of test requirements of the at least one test case. The at least one test parameter may include at least one of: a keyword associated with the at least one test requirement, descriptions defining at least a portion of the at least one test requirement, and a tag associated with the at least one test requirement.

According to embodiments, the method may further include: obtaining information associated with one or more users; determining, based on the information of the one or more users, a presentation format; and presenting, based on the mapping and the presentation format, the synchronized test information to the one or more users. The presenting the synchronized test information may include: generating, based on the mapping and the presentation format, a first graphical user interface (GUI); and presenting the first GUI to a first user. Further, the presenting the synchronized test information may include: generating, based on the mapping and the presentation format, a second GUI; and presenting the second GUI to a second user. The presentation format may be a generic format or a specific format.

According to embodiments, a system for automatically synchronizing test information of a testing may be provided. The system may include a memory storage storing instructions and at least one processor communicatively coupling to the memory storage. The at least one processor may be configured to execute the instructions to: collect at least one test result of the testing; determine at least one test case associated with the at least one test result; determine, from among a plurality of test requirements of the at least one test case, at least one test requirement associated with the at least one test result; and synchronize the at least one test result with the at least one test requirement. The testing may include testing of a software of a vehicle system, and the software may include a virtual electronic control unit (ECU).

According to embodiments, the at least one processor may be configured to execute the instructions to synchronize the at least one test result with the at least one test requirement by: generating a mapping of the at least one test result and the determined at least one test requirement. Additionally or alternatively, the at least one processor is configured to execute the instructions to synchronize the at least one test result with the at least one test requirement by: updating a mapping of the at least one test result and the determined at least one test requirement.

According to embodiments, the at least one processor may be configured to execute the instructions to collect the at least one test result by: establishing a communication with at least one test execution environment; gathering, from the a least one test execution environment, one or more test data; and extracting, from the one or more test data, information associated with the test result.

According to embodiments, the at least one processor may be configured to execute the instructions to determine the at least one test case by: processing the at least one test result to obtain at least one identity parameter associated with the at least one test case; and identifying, based on the at least one identity parameter, the at least one test case. The at least one identity parameter may include at least one of: a keyword associated with the at least one test case, a unique identifier (ID) associated with the at least one test case, and a tag associated with the at least one test case.

According to embodiments, the at least one processor may be configured to execute the instructions to determine the at least one test requirement by: processing the at least one test result to obtain at least one test parameter associated with the at least one test requirement; and determining, based on the at least one test parameter, the at least one test requirement from among a plurality of test requirements of the at least one test case. The at least one test parameter comprises at least one of: a keyword associated with the at least one test requirement, descriptions defining at least a portion of the at least one test requirement, and a tag associated with the at least one test requirement.

According to embodiments, the at least one processor may be further configured to execute the instructions to: obtain information associated with one or more users; determine, based on the information of the one or more users, a presentation format; and present, based on the mapping and the presentation format, the synchronized test information to the one or more users. The at least one processor may be configured to execute the instructions to present the synchronized test information by: generating, based on the mapping and the presentation format, a first graphical user interface (GUI); and presenting the first GUI to a first user. Further, at least one processor may be further configured to execute the instructions to present the synchronized test information by: generating, based on the mapping and the presentation format, a second GUI; and presenting the second GUI to a second user. The presentation format may be a generic format or a specific format.

Additional aspects will be set forth in part in the description that follows and, in part, will be apparent from the description, or may be realized by practice of the presented embodiments of the disclosure.

### BRIEF DESCRIPTION OF THE DRAWINGS

Features, advantages, and significance of exemplary embodiments of the disclosure will be described below with reference to the accompanying drawings, in which like reference numerals denote like elements, and wherein:

FIG. 1 illustrates a block diagram of an example system architecture for managing test information associated with a test for testing a software, according to one or more embodiments;

FIG. 2 illustrates a block diagram of example components of a test information management system, according to one or more embodiments;

FIG. 3 illustrates a flow diagram of an example method for automatically synchronizing test information of a test for testing a software, according to one or more embodiments;

FIG. 4 illustrates an example test case and the associated test requirements, according to one or more embodiments;

FIG. 5 illustrates a diagram of an example use case of method 300, according to one or more embodiments;

FIG. 6 illustrates a flow diagram of an example method for presenting the synchronized test information, according to one or more embodiments;

FIG. 7 illustrates an example graphical user interface (GUI), according to one or more embodiments; and

FIG. 8 illustrates another example GUI, according to one or more embodiments.

### DETAILED DESCRIPTION

The following detailed description of exemplary embodiments refers to the accompanying drawings. The foregoing disclosure provides illustration and description but is not intended to be exhaustive or to limit the implementations to the precise form disclosed. Modifications and variations are possible in light of the above disclosure or may be acquired from the practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” “non-limiting exemplary embodiment,” or similar language means that a particular feature, structure, or characteristic described in connection with the indicated embodiment is included in at least one embodiment of the present solution. Thus, the phrases “in one embodiment”, “in an embodiment,” “in one non-limiting exemplary embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure can be practiced without one or more of the specific features or advantages of a particular embodiment. In other instances, additional features and advantages may be recognized in certain embodiments that may not be present in all embodiments of the present disclosure.

In addition, the term “vehicle” or the like, as used herein, may refer to any motorized and/or mechanical machine that may carry or transport people and/or cargo, such as a car, a truck, a motorcycle, a bus, a bicycle, a mobility scooter, and the like.

The terms “testing information”, “test information”, and the like, described herein may refer to information associated with a test for testing a software associated with a vehicle system. Said information may include information of one or more test requirements, information of one or more testing cases, information of one or more testing results, and/or any other suitable information involved in the testing.

The terms “test artifacts”, “testing artifacts”, and the like, described herein may refer to one or more components that constitute a testing. For instance, the test artifacts may include one or more software-based components (e.g., virtual ECU, emulated ECU, vehicle model, etc.), one or more hardware-based components (e.g., physical ECU, vehicle hardware component, etc.), one or more test configuration (e.g., test environment configuration, test cycle, test execution, etc.), one or more test scenarios, one or more test cases, one or more test packages, and the like.

Example embodiments consistent with the present disclosure provide methods, systems, and apparatuses for efficiently and effectively managing test information of a testing. Specifically, example embodiments of the present disclosure provide systems, methods, devices, or the like, which efficiently and effectively synchronize and present test information.

According to embodiments, the systems, methods, or the like, provided by the example embodiments may automatically collect one or more test results, automatically determine test case(s) and test requirement(s) associated with the one or more test results, and automatically synchronize the one or more test results to the corresponding test requirement(s). Further, the systems, methods, or the like, provided by the example embodiments may automatically determine appropriate presentation format according to the user information, and may present the synchronized test information to one or more users according to the appropriate presentation format. The test information may be associated with a test for testing one or more software of one or more vehicle systems, such as one or more in-vehicle ECUs.

Ultimately, example embodiments of the present disclosure enable the test information to be timely and consistently synchronized, and enable the synchronized test information to be effectively and efficiently presented to users with different levels of technical background. Accordingly, the testing of a software may be performed and managed more efficiently, the burden of the users may be significantly reduced, and the time required for developing the software may be significantly reduced.

It is contemplated that features, advantages, and significances of example embodiments described hereinabove are merely a portion of the present disclosure, and are not intended to be exhaustive or to limit the scope of the present disclosure. Further descriptions of the features, components, configuration, operations, and implementations of example embodiments of the present disclosure, as well as the associated technical advantages and significances, are provided in the following.

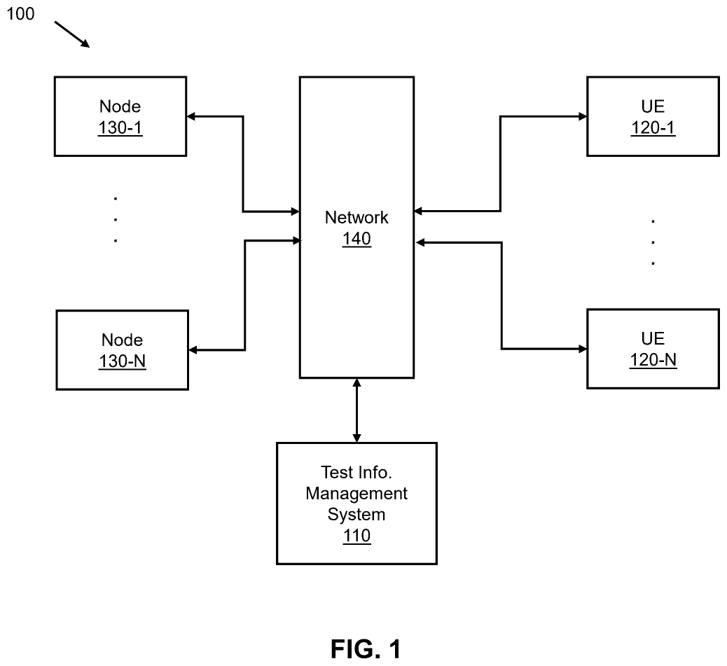

FIG. 1 illustrates a block diagram of an example system architecture 100 for managing test information associated with a test for testing a software, according to one or more embodiments. According to embodiments, the software may include one or more in-vehicle electronic control units (ECUs), such as a physical ECU, an emulated ECU, a virtualized ECU, or a combination thereof. As illustrated in FIG. 1, the system architecture 100 may include a test information management system 110, a plurality of user equipment (UE) 120-1 to 120-N, a plurality of nodes 130-1 to 130-N, and a network 140.

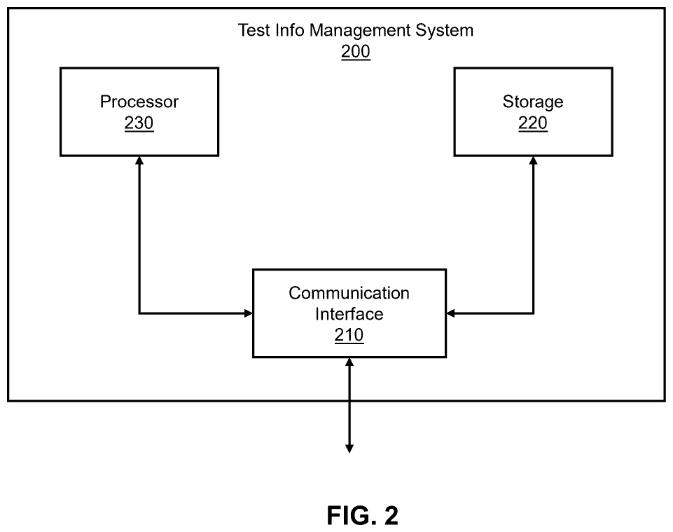

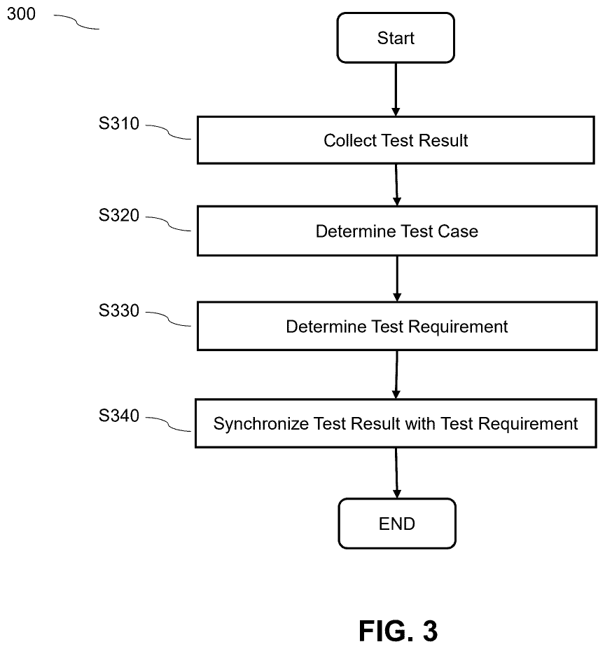

In general, the test information management system 110 may be communicatively coupled to the plurality of UEs 120-1 to 120-N and the plurality of nodes 130-1 to 130-N via the network 140, and may be configured to interoperate with the plurality of UEs 120-1 to 120-N and the plurality of nodes 130-1 to 130-N to manage test information for one or more associated users. Descriptions of example components which may be included in the test information management system 110 are provided below with reference to FIG. 2, and descriptions of the associated operations and use cases are provided below with reference to FIG. 3 to FIG. 8.

Each of the plurality of UEs 120-1 to 120-N may include one or more machines, devices, or the like, which is capable of receiving, generating, storing, processing, and/or providing information upon being utilized by the associated user. For example, one or more of the plurality of UEs 120-1 to 120-N may include a computing device (e.g., a desktop computer, a laptop computer, a tablet computer, a handheld computer, a smart speaker, a server, etc.), a mobile device (e.g., a smartphone, etc.), a wearable device (e.g., a pair of smart glasses or a smart watch), a SIM-based device, or any other suitable device which may be associated with one or more users involved in the testing of the software.

The plurality of UEs 120-1 to 120-N may be utilized by one or more associated users to access and utilize the test information management system 110. For instance, the user(s) may access, via the associated UE, the test information management system 110 to view one or more available test artifacts and/or one or more available test requirements, and to manage one or more test requirements based thereon. Further, the user(s) may also utilize the test information management system 110 to obtain (e.g., view, download, etc.) information associated with one or more test results.

According to embodiments, at least a portion of the plurality of UEs 120-1 to 120-N may be located at different geographical locations. For instance, a first portion of the plurality of UEs 120-1 to 120-N may be utilized by a first user having a first role (e.g., business manager) and the first user may locate at a first location, while a second portion of the plurality of UEs 120-1 to 120-N may be utilized by a second user having a second role (e.g., test engineer) and the second user may locate at a second location different from the first location.

On the other hand, each of the plurality of nodes 130-1 to 130-N may include one or more devices, equipment, systems, or any other suitable components which may receive, host, store, deploy, process, provide, or the like, information and data associated with the testing.

According to embodiments, at least a portion of the plurality of nodes 130-1 to 130-N may be configured to host, deploy, store, provide, or the like, one or more test artifacts or components. For instance, the portion of the plurality of nodes 130-1 to 130-N may include a device or an equipment that may be utilized for building, storing, executing, simulating, executing, or the like, one or more computer-executable software applications, such as one or more virtualized ECUs, one or more emulated ECUs, and/or any other suitable software-based components (e.g., vehicle model, Data Communications Module (DCM) model, Heating, Ventilation, and Air Conditioning (HVAC) model, etc.), of a vehicle system. As another example, the portion of the plurality of nodes 130-1 to 130-N may include or may be communicatively coupled to one or more hardware components, such as one or more fully developed physical ECUs, one or more partially developed physical ECUs, one or more vehicle hardware components (e.g., powertrain, engine, etc.), or the like.

According to embodiments, at least a portion of the plurality of nodes 130-1 to 130-N may be associated with one or more test execution environments. For instance, said portion of nodes may have at least one software-based test execution environment (e.g., software-in-the-loop (SIL) test environment, virtual ECU (V-ECU) test environment, model-in-the-loop (MIL) test environment, processor-in-the-loop (PIL) test environment, etc.) and/or at least one hardware-based test execution environment (e.g., hardware-in-the-loop (HIL) test environment, etc.) communicatively coupled thereto (e.g., wired coupling, wireless coupling, etc.) or deployed thereto.

Further, at least a portion of the plurality of nodes 130-1 to 130-N may include one or more storage mediums, such as a server or a server cluster, which may be configured to store, publish, or the like, one or more data or information provided by the test information management system 110, one or more of the plurality of UEs 120-1 to 120-N, and/or another portion of the plurality of nodes 130-1 to 130-N.

According to embodiments, the plurality of nodes 130-1 to 130-N may include a test management system, which may be configured by one or more users to specify one or more test requirements, to create a test case, to view the test information, and the like.

According to embodiments, one or more of the plurality of nodes 130-1 to 130-N may include one or more interfaces, each of which may be configured to communicatively couple the associated node to the test information management system 110. For instance, the one or more of the plurality of nodes may include a hardware interface, a software interface (e.g., a programmatic interface, application program interface (API), etc.), and/or the like.

According to embodiments, at least a portion of the plurality of nodes 130-1 to 130-N are located at a geographical location different from the test information management system 110, different from one or more of the plurality of UEs 120-1 to 120-N, and/or different from another portion of the plurality of nodes 130-1 to 130-N.

The network 140 may include one or more wired and/or wireless networks, which may be configured to couple the test information management system 110, the plurality of UEs 120-1 to 120-N, and the plurality of nodes 130-1 to 130-N to one another. For example, the network 140 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

According to embodiments, the network 140 may include a virtual network, which may include one or more physical network components (e.g., Ethernet, WiFi module, telecommunication network hardware, etc.) with one or more virtualized network functions (e.g., a control area network (CAN) bus, etc.) implemented therein.

FIG. 2 illustrates a block diagram of example components of a test information management system 200, according to one or more embodiments. The test information management system 200 may be similar to the test information management system 110 in FIG. 1.

As illustrated in FIG. 2, the test information management system 200 may include at least one communication interface 210, at least one storage 220, and at least one processor 230, although it can be understood that the test information management system 200 may include more or less components than as illustrated, and/or the components included therein may be arranged in any a manner different from as illustrated, without departing from the scope of the present disclosure.

The communication interface 210 may include a transceiver-like component (e.g., a transceiver, a separate receiver and transmitter, etc.) that enables the test information management system 200 (or one or more components included therein) to communicate with one or more components external to the test information management system 200, such as via a wired connection, a wireless connection, or a combination of wired and wireless connections. For instance, the communication interface 210 may couple the test information management system 200 (or one or more components included therein) to a plurality of UEs (e.g., UEs 120-1 to 120-N in FIG. 1, etc.) and to a plurality of nodes (e.g., nodes 130-1 to 130-N in FIG. 1, etc.) to thereby enable them to communicate and to interoperate with each. As another example, the communication interface 210 may enable the components of the test information management system 200 to communicate with each other. For instance, the communication interface 210 may couple the storage 220 to the processor 230 to thereby enable them to communicate and to interoperate with each other.

According to embodiments, the communication interface 210 may include a hardware-based interface, such as a bus interface, an Ethernet interface, an optical interface, a coaxial interface, an infrared interface, a radio frequency (RF) interface, a universal serial bus (USB) interface, a Wi-Fi interface, a cellular network interface, a software interface, or the like. According to embodiments, communication interface 210 may include at least one controller area network (CAN) bus configurable to communicatively couple the components of the test information management system 200 (e.g., storage 220, processor 230, etc.) to a plurality of UEs (e.g., UEs 120-1 to 120-N) and to a plurality of nodes (e.g., nodes 130-1 to 130-N). Additionally or alternatively, the communication interface 210 may include a software-based interface, such as an application programming interface (API), a virtualized network interface (e.g., virtualized CAN bus, etc.), or the like.

According to embodiments, the communication interface 210 may be configured to receive information from one or more components external to the test information management system 200 and to provide the same to the processor 230 for further processing and/or to the storage 220 for storing. For instance, the communication interface 210 may receive, from the plurality of UE, one or more user inputs specifying one or more test requirements (e.g., test scenario, test case, test plan, test cycle, etc.) and may provide the same to the processor 230 and/or the storage 220. Similarly, the communication interface 210 may be configured to enable the processor 230 of the test information management system 200 to provide one or more information to one or more components external to the test information management system 200. For instance, the communication interface 210 may enable the processor 230 to present one or more graphical user interfaces (GUIs) to the plurality of UE.

The at least one storage 220 may include one or more storage mediums suitable for storing data, information, and/or computer-readable/computer-executable instructions therein. According to embodiments, the storage 220 may include a random access memory (RAM), a read-only memory (ROM), and/or another type of dynamic or static storage device (e.g., a flash memory, a magnetic memory, and/or an optical memory) that stores information and/or instructions for use by the processor 230.

Additionally or alternatively, the storage 220 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

According to embodiments, the storage 220 may be configured to store information to be utilized by the processor 230 for facilitating automation test information synchronization. For instance, the storage 220 may be configured to store one or more test requirements specified by one or more users, to store information associated with one or more users involved in the testing, to store one or more test results, and the like.

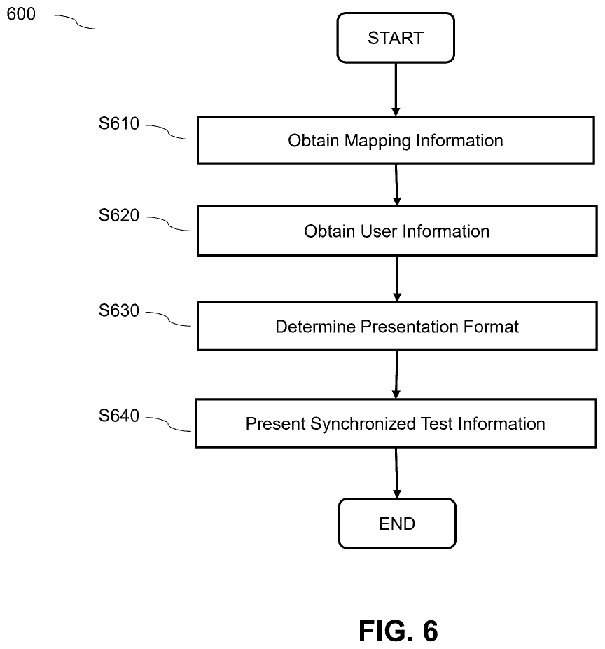

The at least one processor 230 may include one or more processors capable of being programmed to perform a function or an operation for facilitating automation test information synchronization. For instance, the processor 230 may be configured to execute computer-readable instructions stored in a storage medium (e.g., storage 220, etc.) to thereby perform one or more actions or one or more operations described herein. Descriptions of example operations performable by the processor 230 are provided in the following with reference to FIG. 3 and FIG. 6.

According to embodiments, the processor 230 may be configured to receive (e.g., via the communication interface 210, etc.) one or more signals defining one or more instructions for performing one or more operations. Further, the processor 230 may be implemented in hardware, firmware, or a combination of hardware and software. The processor 230 may include a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), and/or another type of processing or computing component.

FIG. 3 illustrates a flow diagram of an example method 300 for automatically synchronizing test information of a test for testing a software, according to one or more embodiments. One or more operations of method 300 may be performed by at least one processor (e.g., processor 230) of the test information management system of example embodiments, upon executing computer-executable instructions stored in at least one memory storage (e.g., storage 220). The software being tested may include an in-vehicle electronic control unit (ECU), and/or any other software components associated with the vehicle system.

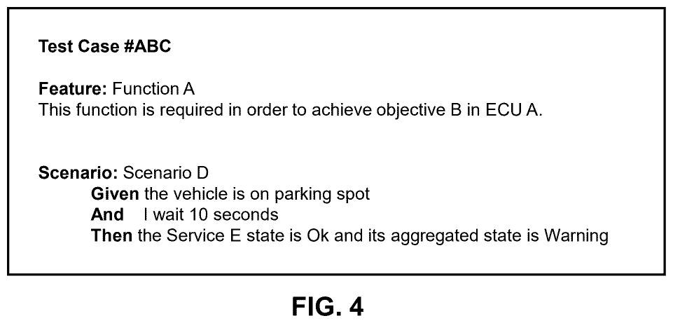

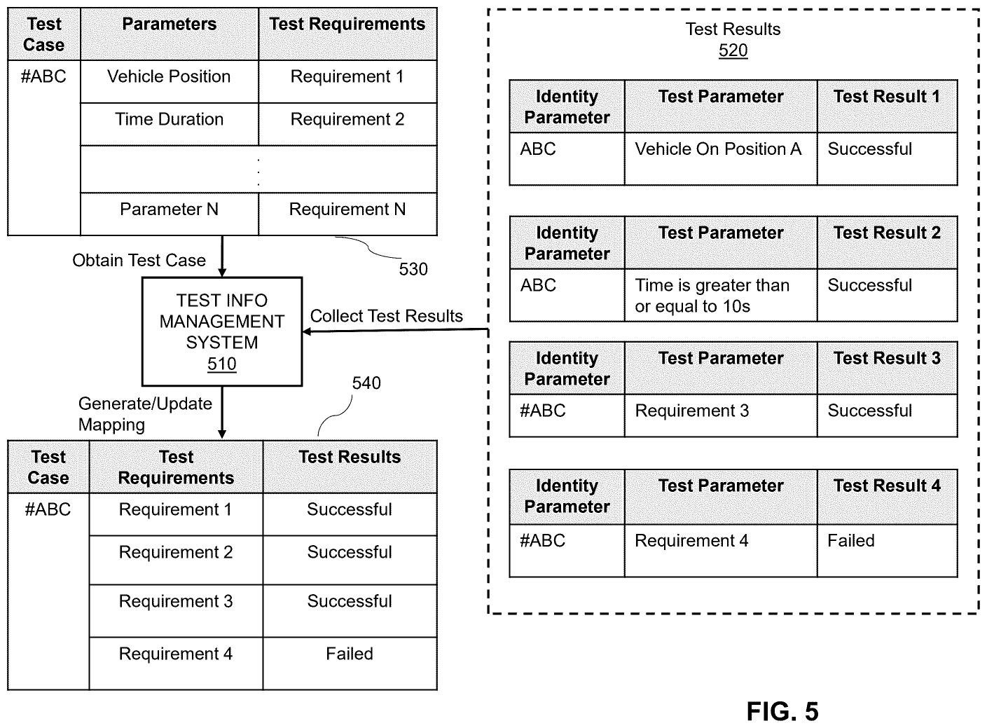

In general, the test information management system (or the at least one processor associated therewith) may be configured to collect one or more test results, to determine one or more test cases associated with the collected one or more test results, and to synchronize the one or more test results with one or more test requirements of the one or more test cases. Descriptions of operations in FIG. 3 are provided below along with descriptions of example use cases in FIG. 4 to FIG. 5.

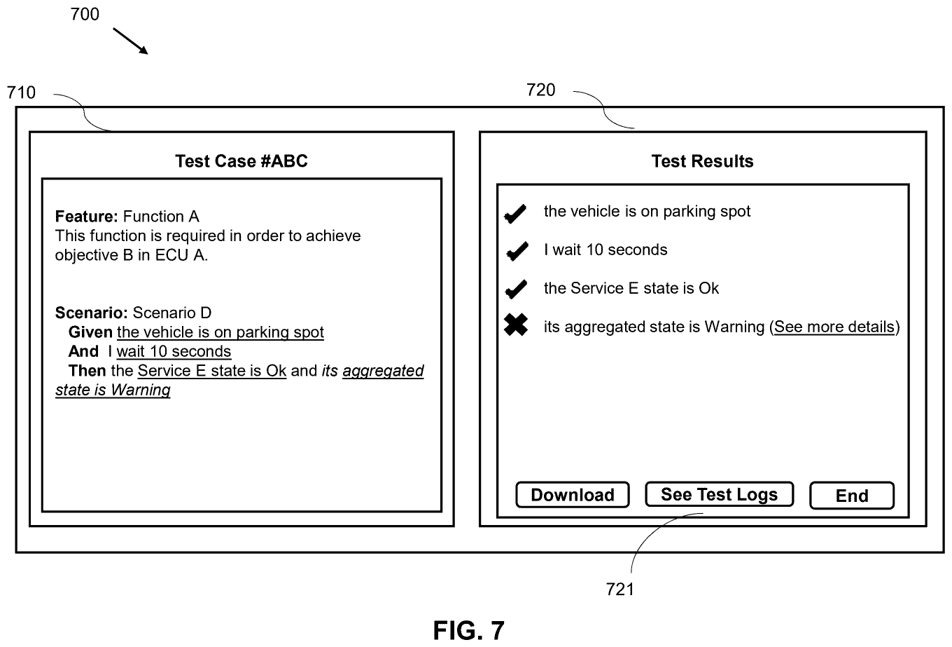

FIG. 4 illustrates an example test case and the associated test requirements, according to one or more embodiments. In this example use case, a test case with and ID “#ABC” includes a plurality of test requirements. The test requirements are associated with a test scenario (illustrated as “Scenario D” in FIG. 4) for testing a function of an ECU (illustrated as “Function A” and “ECU A” in FIG. 4, respectively), while the testing involves testing a service (illustrated as “Service E”). As illustrated in FIG. 4, the feature of the function, as well as the content of the test scenario, are specified in a generic format (further described below with reference to FIG. 6 and FIG. 7). It can be understood that, in addition to test scenario (as illustrated in FIG. 4), other test requirements, such as test plan, test execution, test configuration, test cycle, and the like, may be specified in a similar manner.

The test case in FIG. 4 may be specified or created by a first user via utilizing the test information management system and/or a test management system separated from the test information management system. Upon specifying the test case and the associated test requirements, a testing may be executed based thereon. In this regard, the testing may contain multiple tasks, such as task(s) associated with hardware-based testing and/or task(s) associated with software-based testing, each of which may be assigned to a respective test execution environment. For instance, the task(s) associated with hardware-based testing is assigned to one or more hardware-based test execution environments (e.g., HIL test environments, etc.) while the task(s) associated with software-based testing is assigned to one or more software-based test execution environments (e.g., SIL test environments, etc.). Accordingly, testing of multiple test requirements may be performed at multiple test execution environments, and multiple test results (each associated with a test requirement) may be produced.

Referring back to FIG. 3, at operation S310, the at least one processor of the test information management system may be configured to collect at least one test result. Specifically, the at least one processor may establish a communication (via the communication interface of the test information management system) with at least one node associated with at least one test execution environment, to obtain test data from the at least one node, and to extract information/data associated with the at least one test result from the test data. The information associated with the at least one test result may include an identity parameter (further described below with reference to operation S320), a test parameter (further described below with reference to operation S330), a status of the test (e.g., successful, failed, etc.), log information of the test, images (e.g., screenshots, etc.) of the test, and the like.

According to embodiments at which multiple tests are performed at multiple test execution environments, the at least one processor may simultaneously or sequentially establish communications with multiple nodes associated with the multiple test execution environments to collect multiple test results therefrom, in a similar manner as described above. Descriptions of an example use case associated therewith are provided below with reference to FIG. 5.

According to embodiments, the at least one processor of the test information management system may be configured to continuously (or periodically) communicate with the node(s) associated with the test execution environment(s), so as to continuously (or periodically) collect the test result(s) therefrom in real-time or near real-time.

In view of the above, the at least one processor of the test information management system may be configured to collect a test result as per test requirement, and may thus be able to process the test result and synchronize it with the respective test requirement as soon as the test result is available, without requiring waiting for the completion of testing on all test requirements.

Referring still to FIG. 3, upon collecting the at least one test result at operation S310, method 300 may proceed to operation S320, at which the at least one processor of the test information management system may be configured to determine at least one test case associated with the collected at least one test result.

Specifically, the at least one processor may be configured to process the collected test result to obtain at least one identity parameter associated with the at least one test case. In this regard, the “identity parameter” described herein may refer to a parameter that can be utilized by the at least one processor to identify a target test case. The identity parameter associated with the at least one test case may include one or more of: a keyword associated with the at least one test case, a unique identifier (ID) associated with the at least one test case, names or labels of the at least one test case, and a custom tag associated with the at least one test case.

The at least one processor may be configured to process the obtained at least one test result to obtain one or more identity parameters of the at least one test case, via various operations. For instance, the at least one processor may perform natural language processing (NLP) operations to extract one or more keywords of the at least one test case from the test result, may perform searching operations to determine the ID and/or the custom tag of the at least one test case from the test result, and the like.

Upon obtaining the at least one identity parameter, the at least one processor may be configured to identify the at least one test case associated with the collected at least one test result based on the at least one identity parameter. For instance, assuming that the at least one processor obtained an ID of “#ABC” from the test result, the at least one processor may search, from among a plurality of test cases stored in a storage (e.g., storage 220) and/or managed by a test management system, any test case which has the same ID “#ABC”. It is contemplated that the at least one processor may identify the at least one test case with other identity parameters (e.g., names, labels, tags, etc.) in a similar manner.

Upon identifying the at least one test case based on the at least one identity parameter, the at least one processor may be configured to obtain information of the identified at least one test case. For instance, the at least one processor may obtain the identified at least one test case from the storage of the test information management system. As another example, the at least one processor may obtain (via one or more API calls, etc.) the identified at least one test case from the test management system.

It can be understood that, in some implementations, the at least one processor may be configured to perform operation S320 prior to operation S310, without departing from the scope of the present disclosure. For instance, the at least one processor may first receive at least one test case, may determine parameter(s) associated with one or more test requirements of the at least one test case, and may collect one or more test results associated with the one or more test requirements based on the determined parameter(s).

Further, at operation S330, the at least one processor of the test information management system may be configured to determine, from among a plurality of test requirements of the at least one test case, at least one test requirement that is associated with the at least one test result.

Specifically, the at least one processor may be configured to process the collected at least one test result to obtain at least one test parameter. In this regard, the “test parameter” described herein may refer to a parameter that can be utilized by the at least one processor to identify a target test requirement. The test parameter may include one or more of: a keyword associated with the at least one test requirement, descriptions defining a test requirement, and a custom tag associated with the at least one test requirement. The at least one processor may be configured to obtain one or more test parameters in a similar manner of obtaining the one or more identity parameters (e.g., performing NLP operations, performing searching operations, etc.).

Upon determining the at least one test requirement, method 300 may proceed to operation S340, at which the at least one processor of the test information management system may be configured to synchronize the at least one test result with the at least one test requirement. According to embodiments, the at least one processor may synchronize the at least one test result with the at least one test requirement by generating a mapping of the at least one test result and the at least one test requirement. According to embodiments at which a mapping has been generated in a previous operation, the at least one processor may obtain (from the storage of the test information management system, etc.) the generated mapping and may update the generated mapping with the latest test results. Descriptions of an example mapping are provided below with reference to FIG. 5.

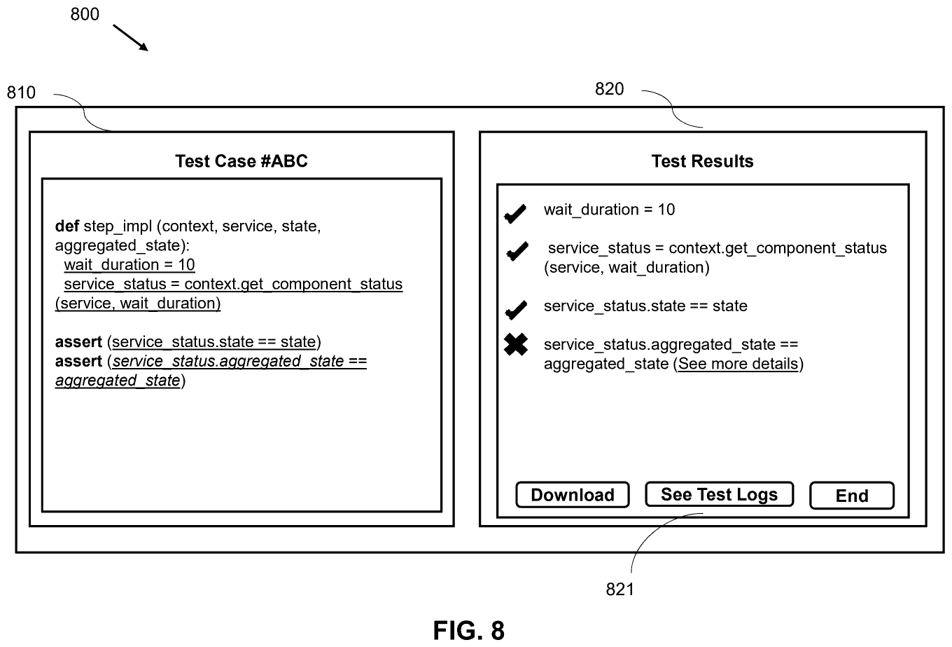

According to embodiments, upon synchronizing the at least one test result with the at least one test requirement, the at least one processor of the test information management system may be configured to present the synchronized information to one or more users. For instance, at least one processor may generate, based on the mapping of the at least one test result and the at least one test requirement, at least one GUI containing the information of the mapping, and may present the at least one GUI to an associated user by sending the at least one GUI to at least one UE associated with the user. Alternatively or additionally, the at least one processor may provide the mapping to the test management system, and the test management system may be configured to generate and present the at least one GUI to the user thereafter. According to embodiments, the at least one GUI may be generated based on user information (e.g., user role, etc.). Descriptions of example GUIs containing the synchronized information are provided below with reference to FIG. 7 and FIG. 8.

In the following, descriptions of an example use case of method 300 are provided with reference to FIG. 5. In general, the test information management system 510 (or the at least one processor associated therewith) may be configured to collect multiple test results 520, may determine and obtain a test case 530 associated with the collected test results, and may synchronize the collected test results with the associated test requirements of the test case 530 by generating/updating a mapping 540. The test information management system 510 may be similar to the test information management system described herein with reference to other Figures.

The test results 520 may include test results 1 to 4, each of which may be associated with a test requirement of a test case (e.g., test case of FIG. 4). At least a portion of the test results 1 to 4 may be associated with testing performed at different test execution environments and may be collected by the test information management system 510 (or the at least one processor associated therewith) from different nodes. In this regard, the test information management system 510 (or the associated processor) may be configured to perform operation S310 to concurrently (or sequentially) communicate with multiple nodes to collect multiple test results therefrom.

Upon obtaining at least one of the test results 1 to 4, the test information management system 510 (or the at least one processor associated therewith) may be configured to associate the obtained test result(s) with the corresponding test case(s). Specifically, the test information management system 510 (or the at least one processor associated therewith) may perform operation S320 to obtain an identity parameter from the test result(s), to determine (based on the identity parameter) at least one test case associated with the at least one test result and to obtain information of the at least one test case thereafter. For instance, upon collecting at least one of the test results 1 to 4, the test information management system 510 (or the at least one processor associated therewith) may be configured to obtain at least one identity parameter from the collected test result(s). In the example use case of FIG. 5, the test results 1 and 2 include keywords of a test case (illustrated as “ABC” in FIG. 5), and the test results 3 and 4 include an ID of the test case (illustrated as “#ABC” in FIG. 5). Based on the identity parameter, the at least one processor may determine that the collect test result(s) is associated with a test case with an ID of “#ABC” or with a name/ID/descriptions associated with keywords of “ABC”. Accordingly, the at least one processor may be configured to obtain information of the determined test case(s).

It can be understood that, in some implementations, the test information management system 510 (or the at least one processor associated therewith) may be configured to first obtain the information of the test case (e.g., obtain from a storage of the test information management system 510, obtain from a test management system, etc.), and to collect the test result(s) associated with the test case thereafter, without departing from the scope of the present disclosure.

Upon obtaining the test result(s) and the information of the associated test case(s), the test information management system 510 (or the at least one processor associated therewith) may be configured to associate the obtained test result(s) with the corresponding test requirement(s) of the test case(s). Specifically, the test information management system 510 (or the at least one processor associated therewith) may perform operation S330 to obtain a test parameter from the test result(s) and to determine (based on the test parameter) at least one test requirement associated with the at least one test result, from among a plurality of test requirements of the test case(s). For instance, in the example use case of FIG. 5, the test case 530 includes a plurality of test requirements 1 to N each of which has a parameter associated therewith, while the test results 1 and 2 include keywords defining a respective test requirement, and the test results 3 and 4 include a description of the test requirement. Based on the test parameter, the at least one processor may determine that the test requirement(s) associated with the collected test result(s).

Subsequently, the test information management system 510 (or the at least one processor associated therewith) may be configured to perform operation S340 to synchronize the obtained test result(s) with the corresponding test requirement(s). For instance, the at least one processor may generate a new mapping 540 (or may update a generated mapping 540) which includes the synchronized information.

Upon synchronizing the test information (e.g., information of a test result and the corresponding test requirement), the test information management system 510 (or the at least one processor associated therewith) may be configured to present the synchronized test information to one or more users. Descriptions of an example method associated therewith are presented below with reference to FIG. 6, and descriptions of example GUIs associated therewith are presented below with reference to FIG. 7 and FIG. 8.

FIG. 6 illustrates a flow diagram of an example method 600 for presenting the synchronized test information, according to one or more embodiments. One or more operations of method 600 may be performed by the at least one processor of the test information management system, and/or may be performed by a system/device different from the test information management system (e.g., a test management system, etc.).

As illustrated in FIG. 6, at operation S610, mapping information is obtained. According to embodiments at which the operation S610 is performed by the test information management system (or the at least one processor associated therewith), the mapping information may be obtained in real-time or near real-time via method 300, or may be obtained from the storage (e.g., storage 220) of the test information management system. According to embodiments at which the operation S610 is performed by a test management system, the mapping information may be obtained by the test management system from the test information management system via one or more API calls.

Upon obtaining the mapping information, the method 600 may proceed to operation S620, at which information of one or more users associated with the test case or the testing is obtained. For instance, the test information management system (or the at least one processor associated therewith) may determine, based on test case information (e.g., identity parameters such as test case ID, keywords, tag, etc.) included in the mapping information, one or more users which are associated with the test case or the testing, and may then obtain the information of said one or more users (e.g., from the storage 220, from a node hosting the user information, etc.) thereafter. The information of the user may include a role of the user, a job title of the user, a job descriptions of the user, an historical presentation information, and/or the like. It is contemplated in the embodiments at which the operation S620 is performed by the test management system, the test management system may be configured to obtain the user information in a similar manner.

Upon obtaining the user information, the method 600 may proceed to operation S630, at which a presentation format associated with the user is determined. For instance, the test information management system (or the at least one processor associated therewith) may determine, based on the user information (e.g., the role/persona/job information of the user), the presentation format which includes information suitable to the user.

According to embodiments, the presentation format may include a generic format or a specific format. In this regard, the term “generic format” described herein may refer to any format of presentation including descriptions that may be understood by a user who does not have (or has limited) a certain level of technical background. Conversely, the term “specific format” described herein may refer to any format of presentation including descriptions that may be understood by a user who has a certain level of technical background. For instance, the specific format may refer to the programming code or any other computer-executable language, which may be understood by a user who has knowledge of the specific type of programming code or the system. It is contemplated in the embodiments at which the operation S630 is performed by the test management system, the test management system may be configured to determine the presentation format in a similar manner.

Upon determining the presentation format, the method 600 may proceed to operation S640, at which the synchronized test information is presented. For instance, the test information management system (or the at least one processor associated therewith) may generate, based on the mapping information and the presentation format, a GUI including the synchronized test information, and may present the GUI to the user thereafter. The generated GUI may present the synchronized test information in presentation format associated with the user. It is contemplated in the embodiments at which the operation S640 is performed by the test management system, the test management system may be configured to present the synchronized test information in a similar manner.

To this end, the synchronized test information may be efficiently and effectively presented to the user. Specifically, the GUI presented to the user may include appropriate content that is suitable for the user in view of the level of technical background of the user. Descriptions of an example GUI generated according to a generic format are provided below with reference to FIG. 7, and descriptions of an example GUI generated according to a specific format are provided below with reference to FIG. 8.

FIG. 7 illustrates an example GUI 700, according to one or more embodiments. The GUI 700 may be generated by the at least one processor of the test information management system (or the test management system) and be presented to a first user (via the UE associated with the first user), so as to present the first user with the synchronized test information in the generic format.

As illustrated in FIG. 7, the GUI 700 may include a first portion 710 and a second portion 720. The first portion 710 may include the descriptions of one or more test requirements of a test case, while the second portion 720 may include the synchronized test information (i.e., the one or more test results along with the corresponding one or more test requirements) and a plurality of interactive elements 721.

According to embodiments, the one or more test requirements in the first portion 710 may be presented in the form of one or more interactive elements (e.g., selectable text, etc.), such that whenever the first user interacts with the intended test requirement(s), the at least one processor may present the associated test result(s) to the first user (e.g., present the test result(s) in an overlay window, highlight the test result(s) in the second portion 820, etc.). In some implementations, the interactive elements associated with the one or more test requirements may be presented according to the associated test result(s). For instance, in the example of FIG. 7, the test requirement “aggregated state is Warning” is presented in italic format, so as to notify the user that said requirement has a test result (e.g., failure) different from other test requirements (e.g., successful).

Further, in the example of FIG. 7, the one or more test results are presented in a respective icon (e.g., a tick icon defines a test result of “Successful”, a cross icon defines a test result of “Failed”, etc.) in the second portion 720. It can be understood that, alternative to or in addition to the icon-based presentation, the test result(s) may be presented in the form of text-based presentation (e.g., the terms “Successful”, “Failed”, or the like may be presented, etc.), in the form of color-based presentation (e.g., green color indicates the test result of “Successful”, red color indicates the test result of “Failed”, etc.).

Furthermore, the test requirement(s) may be presented along with one or more interactive elements (e.g., selectable text, button, etc.), such that upon interaction by the first user, the at least one processor may present more details associated with the test result(s). For instance, in the example of FIG. 7, the test requirement “its aggregated state is Warning” is presented along with selectable texts “see more details”. Upon determining an user interaction on said selectable text, the at least one processor may update the GUI 700 to present (e.g., in a pop-up window, etc.) further information of the associated test result (e.g., reason of failure, etc.)

In addition, each of the plurality of interactive elements 721 may, when being interacted by the first user, perform one or more operations for managing the test result(s). For instance, in the example of FIG. 7, the “Download” button may, upon being interacted by the first user, provide the test result(s) and information associated therewith (e.g., test logs, etc.) to the UE associated with the first user. Further, the “See Test Logs” button may, upon being interacted by the first user, configure the at least one processor to present the test logs to the first user (in a pop-up window, etc.). Furthermore, the “End” button may, upon being interacted by the first user, allow the first user to end the current process (e.g., closing the GUI 700, redirecting the first user to a page prior to GUI 700, etc.). It can be understood that the GUI 700 may include any other suitable interactive elements associated with any other suitable operations, without departing from the scope of the present disclosure.

FIG. 8 illustrates another example GUI 800, according to one or more embodiments. The GUI 800 may be generated by the at least one processor of the test information management system (or the test management system) and be presented to the second user (via the UE associated with the second user), so as to present to the second user the synchronized test information in the specific format.

The components of GUI 800 may be similar to those in GUI 700 (described above with reference to FIG. 7). For instance, GUI 800 may also include a first portion 810 which may include the descriptions of one or more test requirements of the test case, while the second portion 820 may include the synchronized test information (i.e., the one or more test results along with the one or more test requirements) and a plurality of interactive elements 821. Further, the GUI 800 may also be generated and presented by the at least one processor in a similar manner as described hereinabove with reference to FIG. 700. The content of GUI 800 is different from GUI 700 in that, the test requirement(s) is presented in the specific format in the first portion 810, and the test result(s) are presented along with the associated test requirement(s) in the specific format in the second portion 820. Thus, redundant descriptions associated with the components in GUI 800 may be omitted below for conciseness.

To this end, example embodiments of the present disclosure provide a test information management system (and a method for utilizing the same) which may automatically collect, process, and, synchronize test information. Further, the test information management system may present the synchronized test information to multiple users in a presentation format suitable to each of the users. Ultimately, example embodiments of the present disclosure enable the test information to be synchronized and presented automatically, effectively, and efficiently, which in turn addresses the problems in the related art as described above.

It is understood that the specific order or hierarchy of blocks in the processes/flow diagrams disclosed herein is an illustration of example approaches. Based on design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

Some embodiments may relate to a system, a method, and/or a computer-readable medium at any possible technical detail level of integration. Further, as described hereinabove, one or more of the above components described above may be implemented as instructions stored on a computer-readable medium and executable by at least one processor (and/or may include at least one processor). The computer-readable medium may include a computer-readable non-transitory storage medium (or media) having computer-readable program instructions thereon for causing a processor to carry out operations.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object-oriented programming languages such as Smalltalk, C++, or the like, and procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects or operations.

These computer-readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or another device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer-readable media according to various embodiments. In this regard, each block in the flowchart or block diagrams may represent a module, segment, or portion of instructions, which comprises one or more executable instructions for implementing the specified logical function(s). The method, computer system, and computer-readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

What is claimed is:

1. A method, implemented by at least one processor, for automatically synchronizing test information of a testing, the method comprises:
collecting at least one test result of the testing;
determining at least one test case associated with the at least one test result;
determining, from among a plurality of test requirements of the at least one test case, at least one test requirement associated with the at least one test result; and
synchronizing the at least one test result with the at least one test requirement.

2. The method according to claim 1, wherein the synchronizing the at least one test result with the at least one test requirement comprises: generating a mapping of the at least one test result and the determined at least one test requirement.

3. The method according to claim 1, wherein the synchronizing the at least one test result with the at least one test requirement comprises: updating a mapping of the at least one test result and the determined at least one test requirement.

4. The method according to claim 1, wherein the collecting the at least one test result comprises:
establishing a communication with at least one test execution environment;
gathering, from the at least one test execution environment, one or more test data; and
extracting, from the one or more test data, information associated with the test result.

5. The method according to claim 1, wherein the determining the at least one test case comprises:
processing the at least one test result to obtain at least one identity parameter associated with the at least one test case; and
identifying, based on the at least one identity parameter, the at least one test case,
wherein the at least one identity parameter comprises at least one of: a keyword associated with the at least one test case, a unique identifier (ID) associated with the at least one test case, and a tag associated with the at least one test case.

6. The method according to claim 1, wherein the determining the at least one test requirement comprises:
processing the at least one test result to obtain at least one test parameter associated with the at least one test requirement; and
determining, based on the at least one test parameter, the at least one test requirement from among a plurality of test requirements of the at least one test case,
wherein the at least one test parameter comprises at least one of: a keyword associated with the at least one test requirement, descriptions defining at least a portion of the at least one test requirement, and a tag associated with the at least one test requirement.

7. The method according to claim 2, further comprises:
obtaining information associated with one or more users;
determining, based on the information of the one or more users, a presentation format; and
presenting, based on the mapping and the presentation format, the synchronized test information to the one or more users.

8. The method according to claim 7, wherein the presenting the synchronized test information comprises:
generating, based on the mapping and the presentation format, a first graphical user interface (GUI); and
presenting the first GUI to a first user,
wherein the presentation format is a generic format.

9. The method according to claim 8, wherein the wherein the presenting the synchronized test information further comprises:
generating, based on the mapping and the presentation format, a second GUI; and
presenting the second GUI to a second user,
wherein the presentation format is a specific format.

10. The method according to claim 1, wherein the testing comprises testing of a software of a vehicle system, and wherein the software comprises a virtual electronic control unit (ECU).

11. A system for automatically synchronizing test information of a testing, the system comprises:
a memory storage storing instructions; and
at least one processor configured to execute the instructions to:
collect at least one test result of the testing;
determine at least one test case associated with the at least one test result;
determine, from among a plurality of test requirements of the at least one test case, at least one test requirement associated with the at least one test result; and
synchronize the at least one test result with the at least one test requirement.

12. The system according to claim 11, wherein the at least one processor is configured to execute the instructions to synchronize the at least one test result with the at least one test requirement by: generating a mapping of the at least one test result and the determined at least one test requirement.

13. The system according to claim 11, wherein the at least one processor is configured to execute the instructions to synchronize the at least one test result with the at least one test requirement by: updating a mapping of the at least one test result and the determined at least one test requirement.

14. The system according to claim 11, wherein the at least one processor is configured to execute the instructions to collect the at least one test result by:
establishing a communication with at least one test execution environment;
gathering, from the at least one test execution environment, one or more test data; and
extracting, from the one or more test data, information associated with the test result.

15. The system according to claim 11, wherein the at least one processor is configured to execute the instructions to determine the at least one test case by:
processing the at least one test result to obtain at least one identity parameter associated with the at least one test case; and
identifying, based on the at least one identity parameter, the at least one test case,
wherein the at least one identity parameter comprises at least one of: a keyword associated with the at least one test case, a unique identifier (ID) associated with the at least one test case, and a tag associated with the at least one test case.

16. The system according to claim 11, wherein the at least one processor is configured to execute the instructions to determine the at least one test requirement by:
processing the at least one test result to obtain at least one test parameter associated with the at least one test requirement; and
determining, based on the at least one test parameter, the at least one test requirement from among a plurality of test requirements of the at least one test case,
wherein the at least one test parameter comprises at least one of: a keyword associated with the at least one test requirement, descriptions defining at least a portion of the at least one test requirement, and a tag associated with the at least one test requirement.

17. The system according to claim 12, wherein the at least one processor is further configured to execute the instructions to:
obtain information associated with one or more users;
determine, based on the information of the one or more users, a presentation format; and
present, based on the mapping and the presentation format, the synchronized test information to the one or more users.

18. The system according to claim 17, wherein the at least one processor is configured to execute the instructions to present the synchronized test information by:
generating, based on the mapping and the presentation format, a first graphical user interface (GUI); and
presenting the first GUI to a first user,
wherein the presentation format is a generic format.

19. The system according to claim 18, wherein the at least one processor is further configured to execute the instructions to present the synchronized test information by:
generating, based on the mapping and the presentation format, a second GUI; and
presenting the second GUI to a second user,
wherein the presentation format is a specific format.

20. The system according to claim 11, wherein the testing comprises testing of a software of a vehicle system, and wherein the software comprises a virtual electronic control unit (ECU).
